(19) United States
(12) Patent Application Publication
(10) Pub. No.: US 2015/0378862 A1
(43) Pub. Date: Dec. 31, 2015

(54) SELECTION METHOD FOR SELECTING MONITORING TARGET PROGRAM, RECORDING MEDIUM AND MONITORING TARGET SELECTION APPARATUS

(71) Applicant: FUJITSU LIMITED, Kawasaki-shi (JP)

(72) Inventors: HUI LI, Obu (JP); Yasuhide Tobo, Chita (JP); Takeshi Kawaguchi, Nagoya (JP); Yoshikazu Oda, Gifu (JP)

(21) Appl. No.: 14/738,306

(22) Filed: Jun. 12, 2015

(30) Foreign Application Priority Data
Jun. 27, 2014 (JP) 2014-132954

(51) Int. Cl. G06F 11/34; G06F 11/30

(52) U.S. Cl. CPC G06F 11/3409; G06F 11/302

(57) ABSTRACT

A computer identifies a program in which a command history issued to an operating system meets a specific pattern from among a plurality of programs run in a monitoring target system, and selects one or more residual programs as a monitoring target, the one or more residual programs being obtained by excluding the identified program from the plurality of programs.

### CROSS-REFERENCE TO RELATED APPLICATION

This application is based upon and claims the benefit of priority of the prior Japanese Patent Application No. 2014-132954, filed on Jun. 27, 2014, the entire contents of which are incorporated herein by reference.

### FIELD

The embodiments discussed herein are related to a technique of selecting a monitoring target program.

### BACKGROUND

A program or a process operating in a monitoring target system is selected in advance and abnormality is detected in order to monitor the system. Also, a monitoring program that monitors the operations of programs operates so as to detect abnormality in each system.

As a first technique, there is a failure detection system that detects a performance failure in a computer system (for example Patent Document 1). The failure detection system includes a program behavior detection unit, a performance information collection unit, a performance pattern output unit and a performance failure detection unit. The program behavior detection unit detects that a monitoring target program operating in a computer system has executed monitoring target behavior. The performance information collection unit collects pieces of performance information, which represents performance related to the monitoring target program, at a timing when it has been detected that the monitoring target program executed monitoring target behavior. The performance pattern output unit generates a performance pattern, which is a result of associating monitoring target behavior executed by the monitoring target program and performance information related to the monitoring target program for patterning. The performance failure detection unit checks the performance pattern with a performance pattern under a normal circumstance so as to detect performance failure.

As a second technique, there is a computer mutual monitoring method (for example Patent Document 2). According to the computer mutual monitoring method, a computer monitoring program monitoring unit of the method calls a computer monitoring program operation confirmation response unit of the method so as to confirm the operation of the computer monitoring program of the method. When called, the computer monitoring program operation confirmation response unit of the method returns the operation status of the computer monitoring program of the method. A monitored computer management program monitoring unit calls a monitored computer management program operation confirmation response unit so as to confirm the operation of a monitored computer management program. When called, the monitored computer management program monitoring unit returns the operation status of the monitored computer management program.

Patent Document 1: Japanese Laid-open Patent Publication No. 2011-198087

Patent Document 2: Japanese Laid-open Patent Publication No. 2004-341779

Patent Document 3: Japanese Laid-open Patent Publication No. 2002-328850

### SUMMARY

In a selection method for selecting a monitoring target program, a computer executes the following process. Specifically, the computer identifies a program in which a command history issued to an operating system meets a specific pattern from among a plurality of programs run in a monitoring target system. The computer selects one or more residual programs as a monitoring target. The one or more residual programs are obtained by excluding the identified program from the plurality of programs.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a monitoring target selection apparatus according to the present embodiment;

FIG. 2 illustrates a functional block diagram of a server according to the present embodiment;

FIG. 3 illustrates an overall process according to the present embodiment;

FIG. 4 explains process patterns of a monitoring program;

FIG. 5 illustrates an example of master pattern information in the present embodiment;

FIG. 6 illustrates a configuration of a server in an example of the present embodiment;

FIG. 7 illustrates an example of a log file (trace information) output from a log output unit according to an example of the present embodiment;

FIG. 8 illustrates an example of a master information table according to an example of the present embodiment;

FIG. 9 illustrates an example of an operation mode table according to an example of the present embodiment;

FIG. 10 illustrates an example of an operation time table according to an example of the present embodiment;

FIG. 11 illustrates an example of a pattern work table according to an example of the present embodiment;

FIG. 12 illustrates an example of a pattern detail work table according to an example of the present embodiment;

FIG. 13 illustrates a process flow of a management unit according to an example of the present embodiment;

FIG. 14 illustrates a process flow of a log output unit according to an example of the present embodiment;

FIG. 15 illustrates a process flow of an identifying unit according to an example of the present embodiment;

FIG. 16 illustrates the process in S33 in detail;

FIG. 17 illustrates the process in S34 in detail;

FIG. 18 illustrates the process in S51 in detail;

FIG. 19 illustrates the process in S52 in detail;

FIG. 20 illustrates the process in S35 in detail;

FIG. 21 illustrates a process flow of a monitoring unit according to an example of the present embodiment; and

FIG. 22 illustrates an example of a configuration block diagram of a hardware environment of a computer that executes a program according to the present embodiment.

### DESCRIPTION OF EMBODIMENTS

The selection of a monitoring target program and a monitoring target process can be conducted by using various methods in a monitoring target system. However, after conducting selection to some extent, a narrowing operation for excluding unnecessary monitoring target is to be conducted.

When a monitoring program itself has been terminated abnormally, it is not possible to conduct monitoring fully. Meanwhile, it often occurs that administrators do not have enough knowledge as to what types of monitoring programs are operating in each system. Accordingly, it is not possible to determine whether or not to exclude some programs or processes from the monitoring target when the narrowing of monitoring target programs or processes is conducted.

An aspect of the present invention provides a technique of selecting a program that is to be treated as a monitoring target in a monitoring target system.

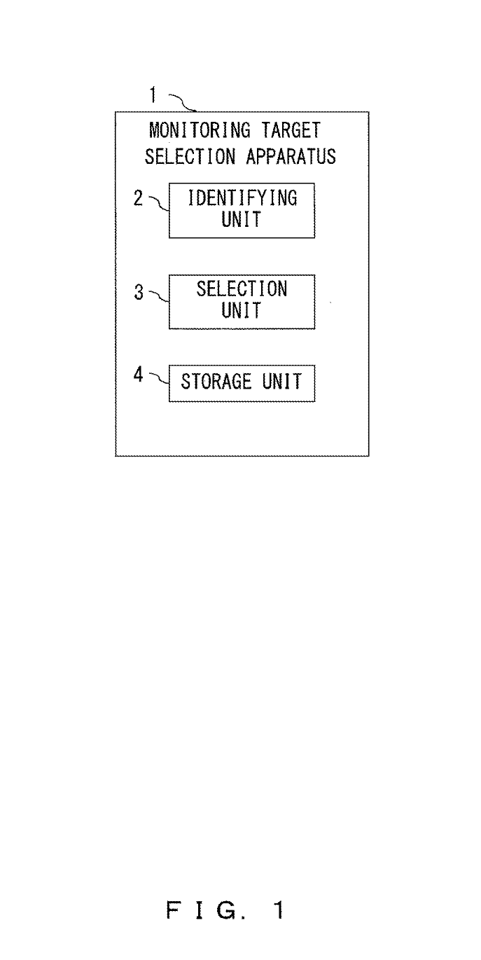

FIG. 1 illustrates an example of a monitoring target selection apparatus according to the present embodiment. A monitoring target selection apparatus 1 includes an identifying unit 2 and a selection unit 3. Examples of the monitoring target selection apparatus 1 include servers 11 and 21.

From among a plurality of programs run in a monitoring target system, the identifying unit 2 identifies a program whose command history issued to the operating system meets a specific pattern. Examples of the identifying unit 2 include an identifying unit 15 that executes the processes in S2-3 and S3 and an identifying unit 24 that executes the processes in S33 and S34.

The selection unit 3 selects one or more residual programs as a monitoring target. The one or more residual programs are obtained by excluding the identified program from the plurality of programs. Examples of the selection unit 3 include the identifying unit 15 that executes the process in S3 and the identifying unit 24 that executes the process in S34.

The above configuration makes it possible to identify a program that is to be treated as a monitoring target in a monitoring target system.

The monitoring target selection apparatus 1 further includes a storage unit 4. The storage unit 4 stores pattern information of sequential-continuous processes, which are executed sequentially and continuously in a program. Examples of the storage unit 4 include a storage unit 31 that stores master pattern information 36.

In such a case, the identifying unit 2 extracts, from the command history, a program that is run continuously for a specific period of time and that executes sequential-continuous processes that are identical to the pattern information. Thereafter, the identifying unit 2 measures execution times of sequential-continuous processes that are executed for a plurality of times in the same program among the extracted programs. Then, the identifying unit 2 identifies a program that meets a specific pattern in accordance with the ratio between the maximum execution time and the minimum execution time that were measured.

The identifying unit 2 further identifies a program that meets a specific pattern in accordance with whether or not the same program has been executed for a plurality of times among the extracted programs.

This configuration makes it possible to exclude, from monitoring target candidate programs, a program having a process pattern similar to a program that needs to be monitored and to determine a small number of programs to be monitoring targets. Thereby, it is possible to reduce loads on a business system.

Hereinafter, the present embodiment will be explained in detail.

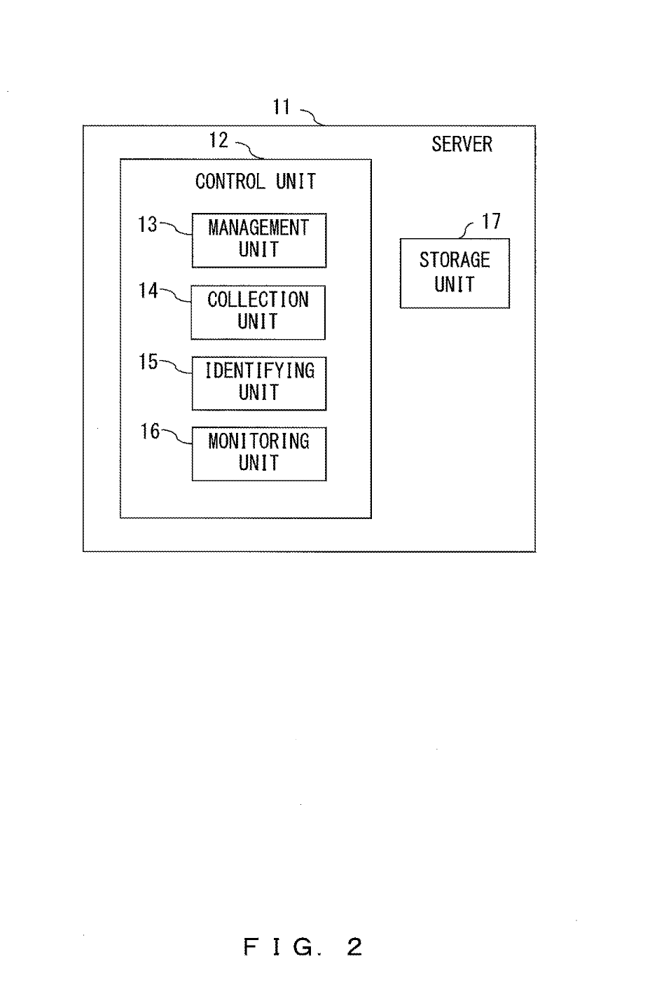

FIG. 2 illustrates a functional block diagram of a server according to the present embodiment. The server 11 includes a control unit 12 and a storage unit 17. The control unit 12 functions as a management unit 13, a collection unit 14, an identifying unit 15 and a monitoring unit 16.

The management unit 13 controls the functions of the collection unit 14, the identifying unit 15 and the monitoring unit 16. The collection unit 14 collects a log (trace information) output from a process that is based on an executed function. The identifying unit 15 identifies a process corresponding to a monitoring program as a monitoring target on the basis of the collected trace information. The monitoring unit 16 monitors a monitoring program corresponding to an identified process.

The storage unit 17 stores collected log (trace information), master pattern information used for identifying a process corresponding to a monitoring program as a monitoring target and a master information table etc. that manages monitoring targets.

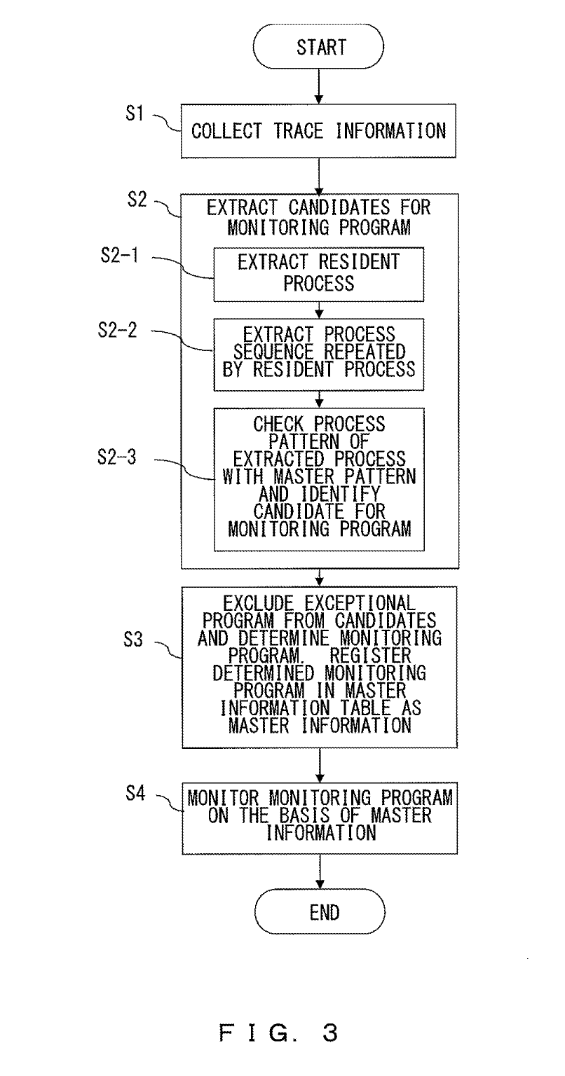

FIG. 3 illustrates an overall process according to the present embodiment. First, the management unit 13 sets the collection mode so that each process outputs trace information. The collection unit 14 collects pieces of trace information output from the respective processes (S1).

Next, the identifying unit 15 extracts candidates for monitoring programs from operating processes (programs) on the basis of the collected trace information and master pattern information that has been registered in advance (S2). The master pattern information is pattern information of a process sequence of at least one function that is executed repeatedly by the execution of a monitoring target program, and is information obtained by patterning a process sequence that is characteristic of an event or a performance monitoring program.

The identifying unit 15 excludes an exceptional program from candidates for monitoring programs and determines a monitoring program to be treated as a monitoring target (S3). The identifying unit 15 registers, as master information, information related to the monitoring program determined to be a monitoring target in the master information table.

The monitoring unit 16 monitors a monitoring program registered in a master information table (S24).

In this example, the processes in S1 through S3 are a monitoring target information collection/registration process for realizing the process in S4 and are executed at the time of the introduction of the present embodiment and are also executed periodically (such as for example once a week) after the introduction so as to update the monitoring target information.

S4 utilizes the monitoring target information collected/registered in S1 through S3, operates daily in the actual usage circumstance, and continues monitoring of operation abnormality of a monitoring program.

Hereinafter, detailed explanations will be given for S1 through S4.

In S1, when the collection mode has been set by the management unit 13 so that each process outputs trace information, the collection unit 14 collects pieces of trace information output from each process. In the present embodiment, the library of a prescribed function has been replaced in advance by the library of a function (wrapper function) resultant from wrapping the library of that function and a function outputting trace information, in addition to the operating system (OS). Thereby, when the corresponding function has been executed, the wrapper function outputs trace information.

In a case of for example Linux, which is an OS, the library of a prescribed function is replaced by the library of a wrapper function in the following order. First, it is assumed for example that the function to be replaced is fork/exec/open/creat/close/unlink/read/write/connect/send/recv/stat/wait. The wrapper function of the function to be replaced is prepared and the wrapper function is generated as a dynamic library.

Next, as a variable for setting a library path such as for example LD_PRELOAD/LD_LIBRARY_PATH, a location of the above dynamic library is set.

Thereby, when the management unit 13 has set the collection mode so that each process outputs trace information, each process outputs trace information. As a result of this, the collection unit 14 can collect pieces of trace information output from each process.

In S2, the identifying unit 15 extracts candidates for a monitoring program from operating processes (programs) on the basis of collected trace information and master pattern information that has been registered in advance.

First, the identifying unit 15 extracts a resident process (S2-1). The identifying unit 15 analyzes the trace information of a process, determines whether or not it is a resident process and extracts a resident process. For example, the identifying unit 15 determines, to be a resident process, a process that has been operating continuously for a prescribed period of time (for example, one day) or longer. As a result of the determination, the identifying unit 15 stores in a resident process table the name of the program of the process determined to be a resident process.

Next, the identifying unit 15 extract a process sequence that is repeated by a resident process (S2-2). The identifying unit 15 analyzes the trace information of a resident process so as to extract a process pattern that is repeated by each process (process sequence, the intervals of the repetition of the sequence and information of whether or not it is periodic).

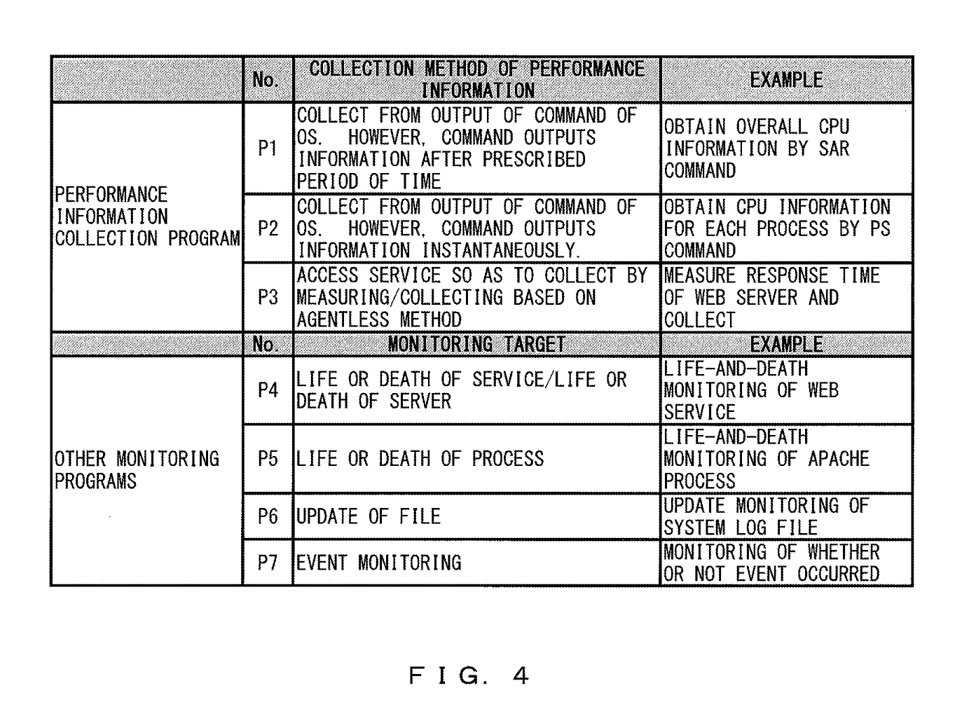

Explanations will be given for a confirmation method of a function executed in a program on the basis of trace information and a master pattern of a process sequence characteristic of a monitoring program. The processes by a monitoring program can be categorized into the patterns illustrated in FIG. 4.

FIG. 4 explains process patterns of a monitoring program. A program that collects pieces of performance information periodically (performance information collection program) can be categorized into patterns P1 through P3.

In the case of pattern P1, the performance information collection program executes a command (a type that outputs information after a prescribed period of time has elapsed) of the OS, and thereby the performance information is collected. In this method, the process includes the repetition of following sequences P1-1 through P1-4.

(P1-1) The performance information collection program executes a command of the OS. In such a case, the fork function and the exec function are executed and accordingly the identifying unit 15 confirms the execution of the fork function and the exec function from output information of the wrapper function. Note that the name of the executed command can be obtained from an argument of the exec function.

(P1-2) The performance information collection program reads an output of the OS. In such a case, the read function is executed and accordingly the identifying unit 15 can confirm the execution of the read function from output information of the wrapper function.

(P1-3) The performance information collection program analyzes the output of the read command of the OS.

(P1-4) The performance information collection program outputs (writes) the analysis result to a file. In such a case, the write function is executed, and accordingly the identifying unit 15 can confirm the execution of the write function from the output information of the wrapper function.

In the above process, the identifying unit 15 can identify the following process sequence as pattern P1 from the output information of the wrapper function.

P1: fork→exec→read→write

An example of pattern P1 is a process sequence that obtains the overall CPU information by the execution of the sar command.

In the case of pattern P2, the performance information collection program executes a command (a type that outputs information instantaneously) of the OS, and thereby collects performance information. In this method, the process includes the repetition of following sequences P2-1 through P2-5.

(P2-1) The performance information collection program executes a command of the OS. In such a case, the fork function and the exec function are executed and accordingly the identifying unit 15 can confirm the execution of the fork function and the exec function from the output information of the wrapper function. Note that the name of the executed command can be obtained from an argument of the exec function.

(P2-2) The performance information collection program reads the output of a command of the OS. In such a case, the read function is executed and accordingly the identifying unit 15 can confirm the execution of the read function from the output information of the wrapper function.

(P2-3) The performance information collection program analyzes the output of the read command of the OS.

(P2-4) The performance information collection program outputs (writes) the analysis result to a file. In such a case, the write function is executed, and accordingly the identifying unit 15 can confirm the execution of the write function from the output information of the wrapper function.

(P2-5) The performance information collection program waits for a prescribed period of time. In such a case, the sleep function is executed, and accordingly the identifying unit 15 can confirm the execution of the sleep function from the output information of the wrapper function).

In the above process, the identifying unit 15 can identify the following process sequence as pattern P2 from the output information of the wrapper function.

P2: fork→exec→read→write→sleep

An example of pattern P2 is a process sequence that obtains the CPU information for each process by the execution of the ps command.

In the case of pattern P3, the performance information collection program accesses services (FTP (file transfer protocol), TELNET, Web (HTTP (HyperText Transfer Protocol)), Web (HTTPS), etc.) so as to measure their performance and collect the information. In this method, the process includes the repetition of following sequences P3-1 through P3-5.

(P3-1) The performance information collection program establishes connection to a service and transmits a request. The performance information collection program uses command “connect” so as to establish connection to a service and uses command “send” so as to transmit a request, and accordingly the identifying unit 15 can confirm commands “connect” and “send” from the output information of the wrapper function. Also, it is possible to obtain the IP (Internet Protocol) address/port number of the service from an argument. For example, when the service is “FTP”, port number “21” is obtained. When the service is “TELNET”, port number “23” is obtained. When the service is “Web (HTTP)”, port number “80” is obtained. When the service is “Web (HTTPS)”, port number “443” is obtained.

(P3-2) The performance information collection program receives a response from the service. The function that receives a response is recv, and the identifying unit 15 can confirm the execution of the recv function from the output information of the wrapper function.

(P3-3) The performance information collection program analyzes the output of the read command of the OS.

(P3-4) The performance information collection program outputs (writes) the analysis result to a file. In such a case, the write function is executed and accordingly the identifying unit 15 can confirm the execution of the write function from the output information of the wrapper function.

(P3-5) The performance information collection program waits for a prescribed period of time. In such a case, the sleep function is executed and accordingly the identifying unit 15 can confirm the execution of the sleep function from the output information of the wrapper function.

In the above process, the identifying unit 15 can identify the following process sequence as pattern P3 from the output information of the wrapper function.

P3: connect→send→recv→write→sleep

As an example of pattern P3, a case where response times of the web server are measured and collected is possible.

Next, a monitoring program other than the performance information collection program can be categorized into patterns P4 through P7.

In the case of pattern P4, for the life-and-death monitoring of service/server such as the life-and-death monitoring of the Web service etc., the process includes the repetition of following sequences P4-1 through P4-5.

(P4-1) The monitoring program establishes connection to a service (FTP (file transfer protocol), TELNET, Web (HTTP (HyperText Transfer Protocol)), Web (HTTPS)), and transmits a request. The monitoring program uses command “connect” so as to establish connection to a service and uses command “send” so as to transmit a request, and accordingly the identifying unit 15 can determine commands “connect” and “send” from the output information of the wrapper function. Also, it is possible to obtain the IP (Internet Protocol) address/port number of a service from an argument.

(P4-2) The monitoring program receives a response from the service. The function that receives a response is recv, and the identifying unit 15 can confirm the execution of the recv function from the output information of the wrapper function.

(P4-3) The monitoring program analyzes the execution result of the recv function.

(P4-4) When the analysis result indicates abnormality in the service, the monitoring program outputs a report.

(P4-5) The monitoring program waits for a prescribed period of time. In such a case, the sleep function is executed and accordingly the identifying unit 15 can confirm the execution of the sleep function from the output information of the wrapper function.

In the above process, the identifying unit 15 can identify the following process sequence as pattern P4 from the output information of the wrapper function.

P4: connect→send→recv→sleep

In the case of pattern P5, for the life-and-death monitoring of a process such as the life-and-death monitoring of the apache process etc., the process includes the repetition of following sequences P5-1 through P5-5.

(P5-1) The monitoring program executes a command of obtaining a process list information. In such a case, the fork/exec function is executed and accordingly the identifying unit 15 confirms the execution of the fork/exec function from the output information of the wrapper function.

(P5-2) The monitoring program reads the output result of a command executed by the fork/exec function. In such a case, the read function is executed and accordingly the identifying unit 15 can confirm the execution of the read function from the output information of the wrapper function.

(P5-3) The monitoring program analyzes the execution result of the read function.

(P5-4) When the analysis result indicates abnormality of the service, the monitoring program outputs a report.

(P5-5) The monitoring program waits for a prescribed period of time. In such a case, the sleep function is executed and accordingly the identifying unit 15 can confirm the execution of the sleep function from the output information of the wrapper function.

In the above process, the identifying unit 15 can identify the following process sequence as pattern P5 from the output information of the wrapper function.

P5: fork→exec→read→sleep

In the case of pattern P6, for the update monitoring of a file such as the update monitoring of a system log file etc., the process includes the repetition of sequences P6-1 through P6-4.

(P6-1) The monitoring program obtains the changing information of a file. Command “stat” is executed and accordingly the identifying unit 15 confirms the execution of command “stat” from the output information of the wrapper function. Also, the filename is identified from an argument.

(P6-2) The monitoring program analyzes the obtained changing information of the file.

(P6-3) The monitoring program outputs the result of the analysis when there was a change in the changing information of the file. In such a case, the write function is executed and accordingly the identifying unit 15 can confirm the execution of the write function from the output information of the wrapper function.

(P6-4) The monitoring program waits for a prescribed period of time. In such a case, the sleep function is executed and accordingly the identifying unit 15 can confirm the execution of the sleep function from the output information of the wrapper function.

In the above process, the identifying unit 15 can identify the following process sequence as pattern P6 from the output information of the wrapper function.

P6: stat→sleep

In the case of pattern P7, for event monitoring such as the monitoring of whether or not an event has occurred, the process includes the repetition of following sequences P7-1 through P7-3.

(P7-1) The monitoring program waits for the occurrence of an event. In such a case, the wait function is executed and accordingly the identifying unit 15 can confirm the execution of the wait function from the output information of the wrapper function.

(P7-2) The monitoring program reads the contents of the event that has occurred. In such a case, the read function is executed and accordingly the identifying unit 15 can confirm the execution of the read function from the output information of the wrapper function.

(P7-3) When an event has occurred, the monitoring program outputs a report. In such a case, the write function is executed and accordingly the identifying unit 15 can confirm the execution of the write function from the output information of the wrapper function.

In the above process, the identifying unit 15 can identify the following process sequence as pattern P7 from the output information of the wrapper function.

P7: wait→read→write

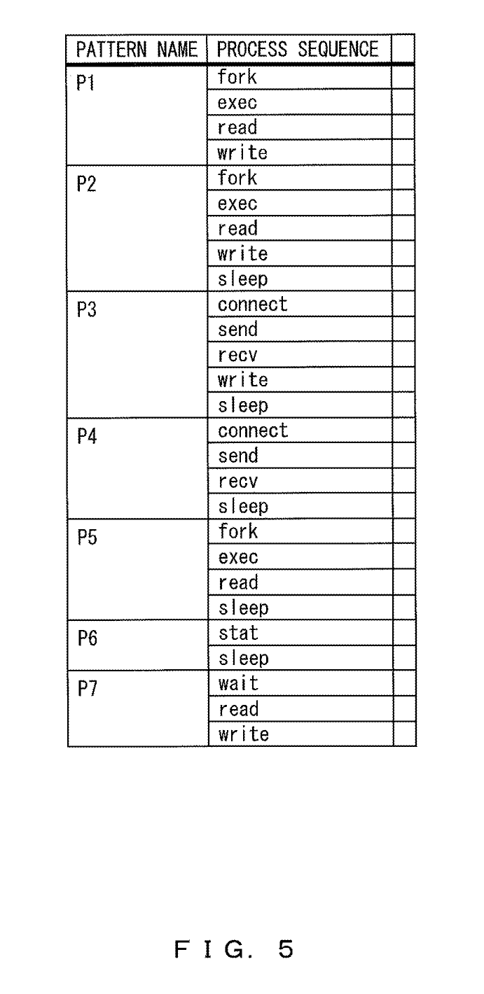

Thereafter, the identifying unit 15 checks the process pattern of the process extracted in S2-2 with the master pattern of a process sequence characteristic of the monitoring program that has been registered in advance so as to identify a candidate for a monitoring program (S2-3). In this example, the identifying unit 15 checks the process sequence of each process extracted in S2-2 with the master pattern (FIG. 5) and extracts a process having an identical pattern as a candidate for a monitoring program.

An example is described in which the checking process in S2-3 determines that a pattern is not a candidate for a monitoring program. Process “apache” is continuously waiting for an HTTP request. When an HTTP request has been received, the process (parent process) activates a child process and make the child process conduct the process of the received request. Then, the parent process again waits for an HTTP request.

The operation sequence of process “apache” is as described below.

recv→fork→exec→wait→recv→fork→exec→wait→(“recv→fork→exec→wait→” represents the repeated sequence)

In the checking process, the above operation sequence and the master pattern of P1 through P7 that is a sequence characteristic of the monitoring program are checked with each other. As a result of the checking, this operation sequence is not identical to any of patterns P1 through P7 and accordingly the identifying unit 15 determines that the apache process is not a candidate for a monitoring program.

Next, in S3, the identifying unit 15 excludes an exceptional program from candidates for a monitoring program, and determines a monitoring program that becomes a monitoring target. The program identified in S2 may also include a control program of on-line business having the characteristics of the repetition of the activation of commands or jobs/request transmission to a remote server and response reception.

In this example, in order to reduce as many loads on the business system as possible, processes other than resident processes of monitoring programs that monitor events or performance information are excluded. A monitoring program has a characteristic that it repeats “same command (request transmission)” at “constant intervals”. The process of excluding exceptional programs is realized by checking the following characteristics, which are different from the above characteristics.

In the case of a control program of an on-line business for example, because an on-line business is conducted when there is a request from a user, the execution of process sequences is not periodic. Accordingly, the cycles in which the process sequence is repeated are checked and when there is a difference of two times or longer between process sequences, it is determined that the program is to be excluded.

In the case of a control program of a batch job, because some batch jobs are executed periodically and other batch jobs are executed on an as-needed bases in response to commands input by a user, the execution of process sequences are both periodic and non-periodic. Accordingly, cycles in which the process sequence is repeated are checked, and when there is a difference of two times or longer, it is determined that the program is excluded. When there is not a difference of two times or longer, the name of the program to be activated is checked and when there are a plurality of programs having the same name, it is determined that those programs having the same name are excluded.

Thereby, the identifying unit 15 excludes a control program of an on-line business and a control program of a batch job from programs identified in S12, and determines a monitoring program to be a monitoring target.

In S14, the identifying unit 15 registers, in the master information table as master information, the pattern information and the related information of the process sequence of the monitoring program determine to be the monitoring target.

FIG. 5 illustrates an example of master pattern information in the present embodiment. Master pattern information stores the execution pattern of a process sequence for each pattern. Master pattern information includes items of “pattern name” and “process sequence”.

Although patterns P1 through P7 illustrated in FIG. 5 are treated as master pattern information in the present embodiment, the scope of the present invention is not limited to this, and any pattern of an operation sequence in which functions are executed sequentially and repeatedly may be registered as master pattern information.

Next, in S24, by using the master information, the monitoring unit 16 monitors the monitoring program determined to be the monitoring target. In this example, trace information of a monitoring process is output from the monitoring program (monitoring target) registered in the master information and trace information is not output from a program that is not a monitoring target.

The monitoring unit 16 analyzes the output trace information and extracts the operation pattern of the monitoring program. The monitoring unit 16 checks the operation pattern obtained as a result of analyzing the trace information with the master pattern stored in the master information table, and determines whether or not the operation of the operating monitoring program is abnormal.

According to the present embodiment, when an event or a process conducting the performance monitoring in a computer is identified, the identifying unit 15 conducts the following processes. Specifically, the identifying unit 15 excludes a process of a sequence similar to the event or the performance monitoring program on the basis of the information of the number/interval of commands (requests) activated (called) by the operating process. Thereby, it is possible to only identify an event or a performance monitoring program. It is also possible to conduct monitoring (of only a small number of processes) without imposing loads on the business server.

Next, detailed explanations will be given for examples of the above described embodiment.

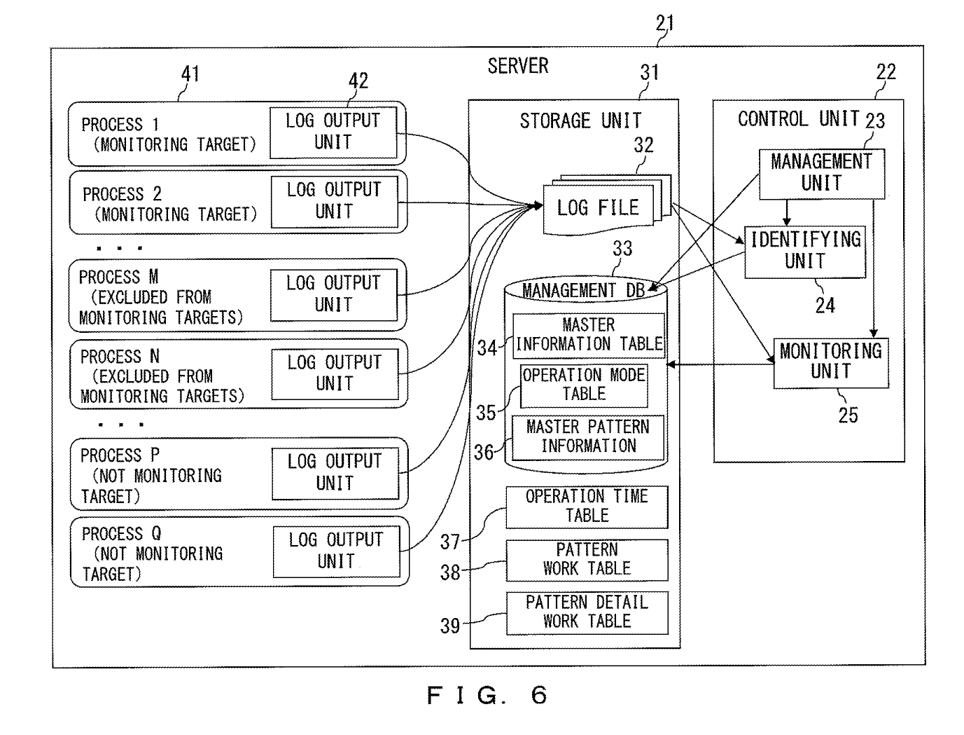

FIG. 6 illustrates a configuration of a server in an example of the present embodiment. The server 21 is a business server in which a business application program is operating. The server 21 includes a control unit 22 and a storage unit 31.

By replacing a prescribed function library with a wrapper function library, each process 41 includes a log output unit 42 upon the activation. The log output unit 42 outputs a log (trace information) based on an executed function.

As the processes 41, there are processes 1, 2, . . . , that are to be monitoring targets, processes M, N, . . . , that are to be excluded from monitoring targets, and processes P, Q, . . . , that are not monitoring targets.

The storage unit 31 stores log files (trace information) 32 output from the log output units 42 of the processes 41, a management DB 33, an operation time table 37, a pattern work table 38, a pattern detail table 39, etc. The management DB 33 stores a master information table 34, an operation mode table 35 and a master pattern information 36. The operation mode table 35 is a table for controlling the operation mode of the control unit 22.

The control unit 22 functions as a management unit 23, an identifying unit 24 and a monitoring unit 25. The management unit 23 controls the function of the monitoring unit 25. The identifying unit 24 identifies a process corresponding to a monitoring program that is a monitoring target and registers it in the master information table 34 on the basis of the log file 32 stored in the storage unit 31. The monitoring unit 25 monitors a monitoring program corresponding to a program registered in the master information table 34.

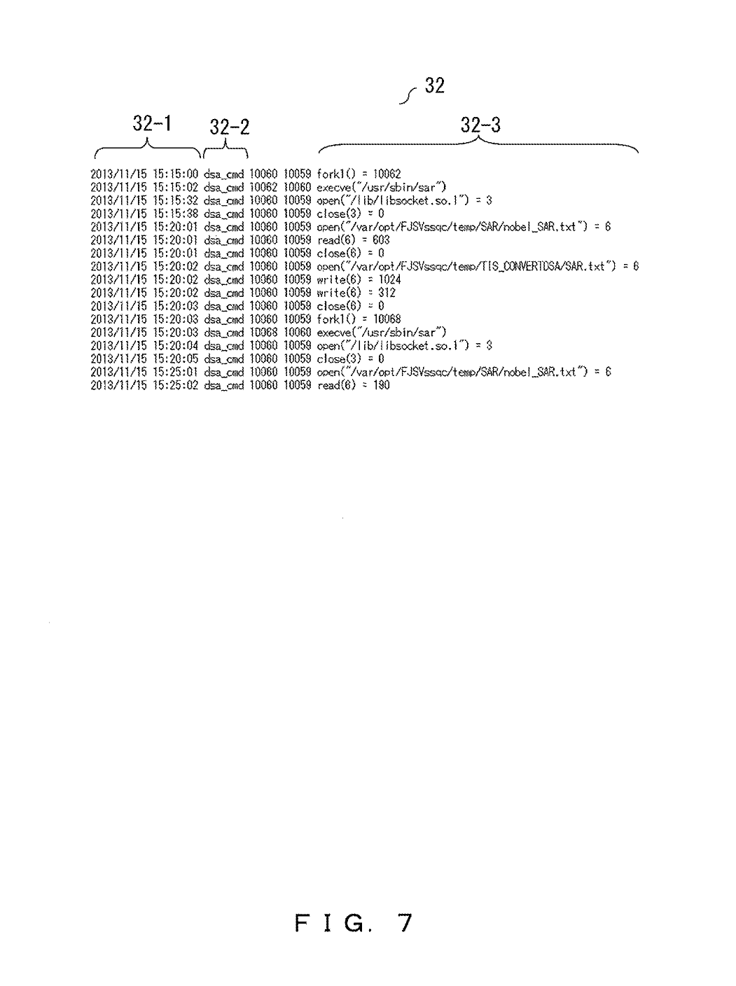

FIG. 7 illustrates an example of a log file (trace information) output from a log output unit according to an example of the present embodiment. The log file 32 includes date/time 32-1 of the execution of the command, a program name 32-2 and function name etc. (argument of that function) 32-3.

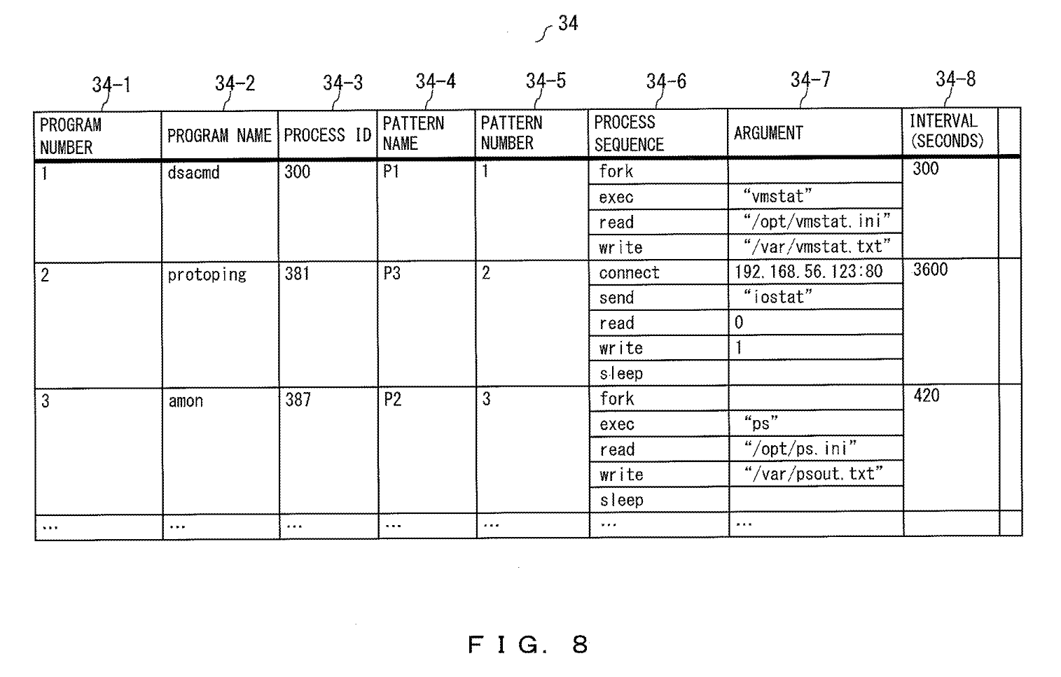

FIG. 8 illustrates an example of a master information table according to an example of the present embodiment. The master information table 34 stores information related to a program (process) that is determined to be a monitoring target. The master information table 34 includes items of a “program number” 34-1, a “program name” 34-2, a “process ID” 34-3, a “pattern ID” 34-4, a “pattern number” 34-5, a “process sequence” 34-6, an “argument” 34-7 and an “interval (seconds)” 34-8.

In the “program number” 34-1, a program number is stored. In the “program name” 34-2, the name of the program is stored. In the “process ID” 34-3, the process ID for identifying the process is stored. In the “pattern ID” 34-4, the pattern ID for identifying the pattern of the process is stored. In the “pattern number” 34-5, the number corresponding to the pattern ID is stored. In the “process sequence” 34-6, a process sequence based on a plurality of continuous functions included in the pattern identified by the pattern ID is stored. In the “argument” 34-7, an argument of the function stored in the “process sequence” 34-6 is stored. In the “interval (seconds)” 34-8, the repetition interval (cycle) of the process sequence is stored.

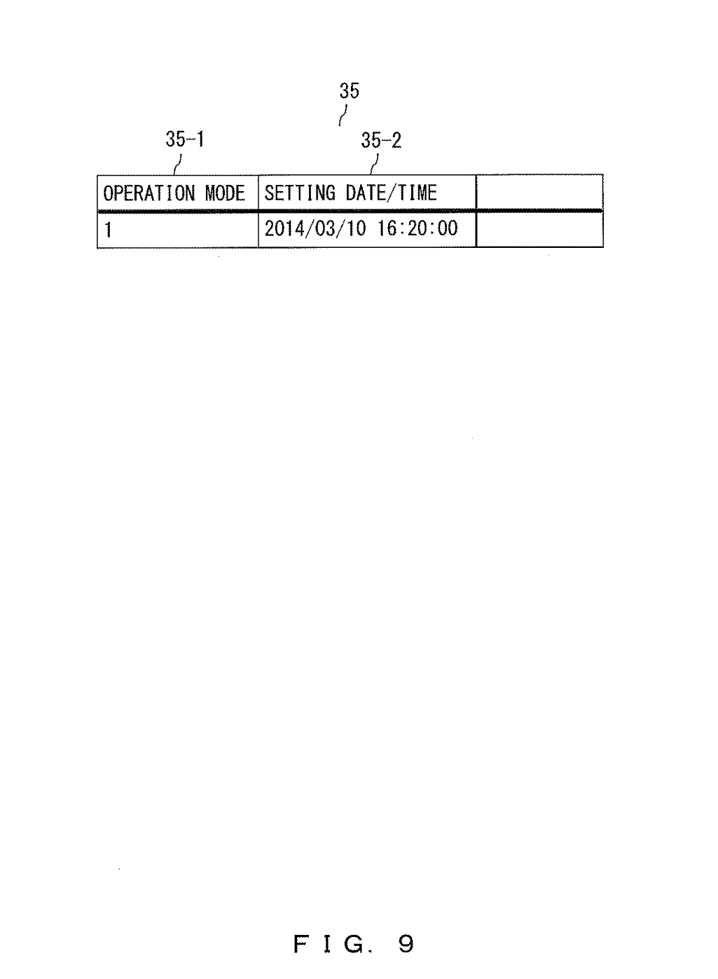

FIG. 9 illustrates an example of an operation mode table according to an example of the present embodiment. The operation mode table 35 includes items of an “operation mode” 35-1 and “setting date/time” 35-2.

In the “operation mode” 35-1, information for controlling the operation mode of the control unit 22 is stored. “Operation mode=1 (collection mode)” represents that the situation is that pieces of monitoring target information is being collected. “Operation mode=2 (monitoring mode)” represents that the situation is that monitoring target information has already been collected and the monitoring is being conducted.

In the “setting date/time” 35-2, the time and date at which the operation mode has been set is stored.

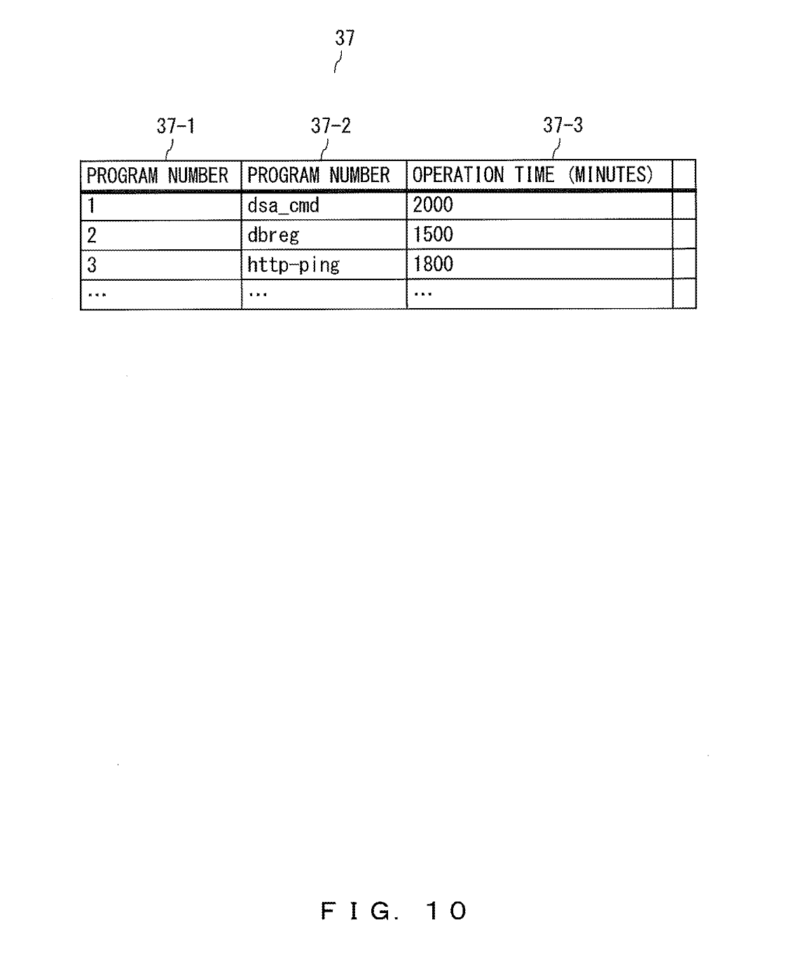

FIG. 10 illustrates an example of an operation time table according to an example of the present embodiment. The operation time table 37 is a table used for determining a resident process. The operation time table 37 includes items of a “program number” 37-1, a “program number” 37-2 and an “operation time (minutes)” 37-3.

In the “program number” 37-1, the number for identifying the program is stored. In the “program number” 37-2, the name of the program is stored. In the “operation time (minutes)” 37-3, the operation time of the program is stored.

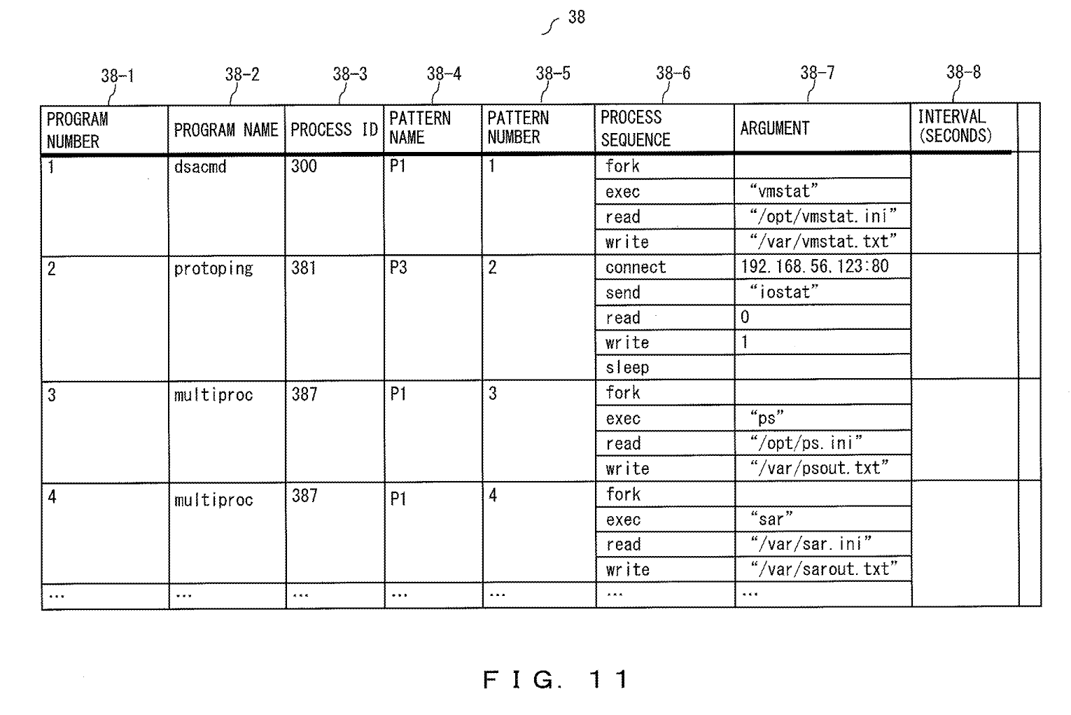

FIG. 11 illustrates an example of a pattern work table according to an example of the present embodiment. The pattern work table 38 is a work table used when information of a monitoring target program is registered in the master information table 34 and when a monitoring target is determined before the monitoring.

The pattern work table 38 includes a “program number” 38-1, a “program name” 38-2, a “process ID” 38-3, a “pattern ID” 38-4, a “pattern number” 38-5, a “process sequence” 38-6, an “argument” 38-7 and an “interval (seconds)” 38-8. The pattern work table 38 and the master information table 34 have the same items.

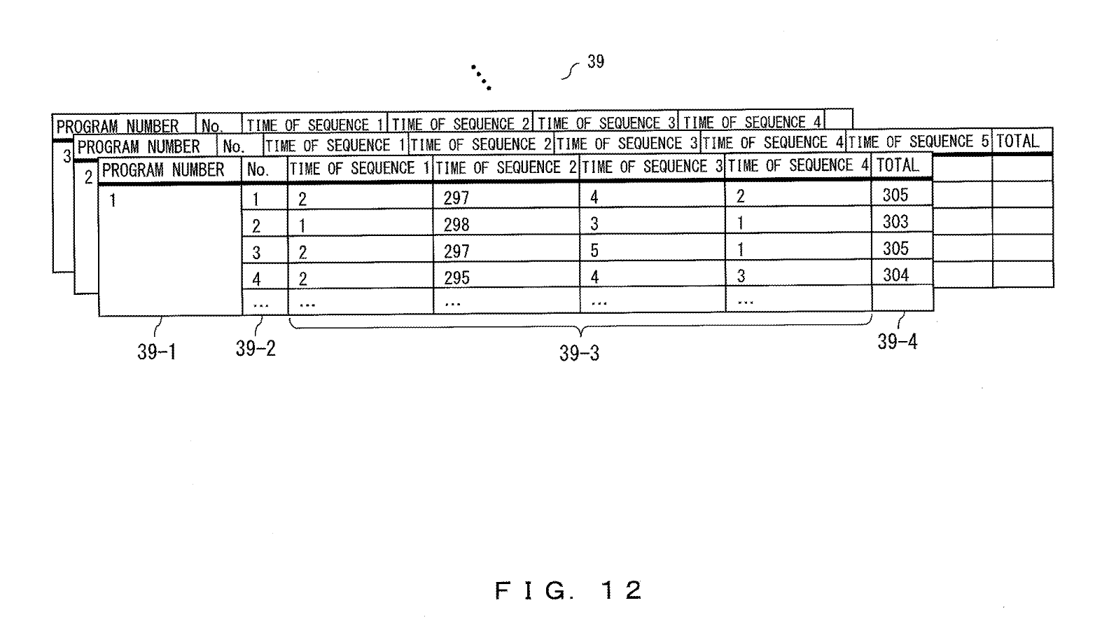

FIG. 12 illustrates an example of a pattern detail work table according to an example of the present embodiment. The pattern detail work table 39 is a detail table corresponding to programs registered in the pattern work table 38 and is a table used for calculating an interval to be registered in the “interval (seconds)” 34-8 in the master information table 34.

The pattern detail work table 39 includes items of a “program number” 39-1, “No.” 39-2, a “sequence time” 39-3 and a “total” 39-4.

In the “program number” 39-1, the program number stored in the “program number” 38-1 in the pattern work table 38 is stored. In the “No.” 39-2, the number of times of execution of the program is stored. The “sequence time” 39-3 is a variable item and the operation time for each sequence of the respective functions registered in the “process sequence” 38-6 in the pattern work table 38 is stored.

Next, explanations will be given for a flow of the processes of an example of the present embodiment.

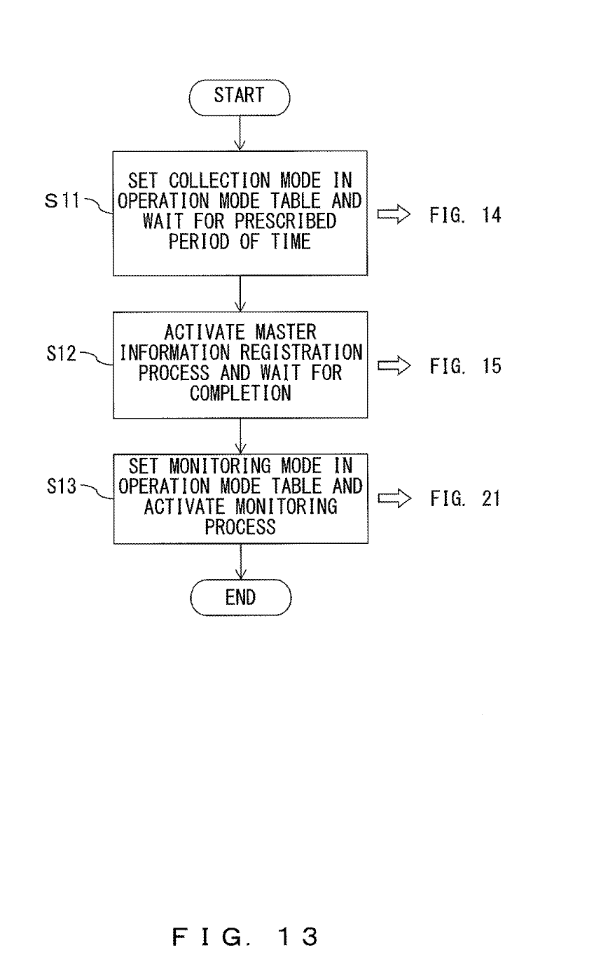

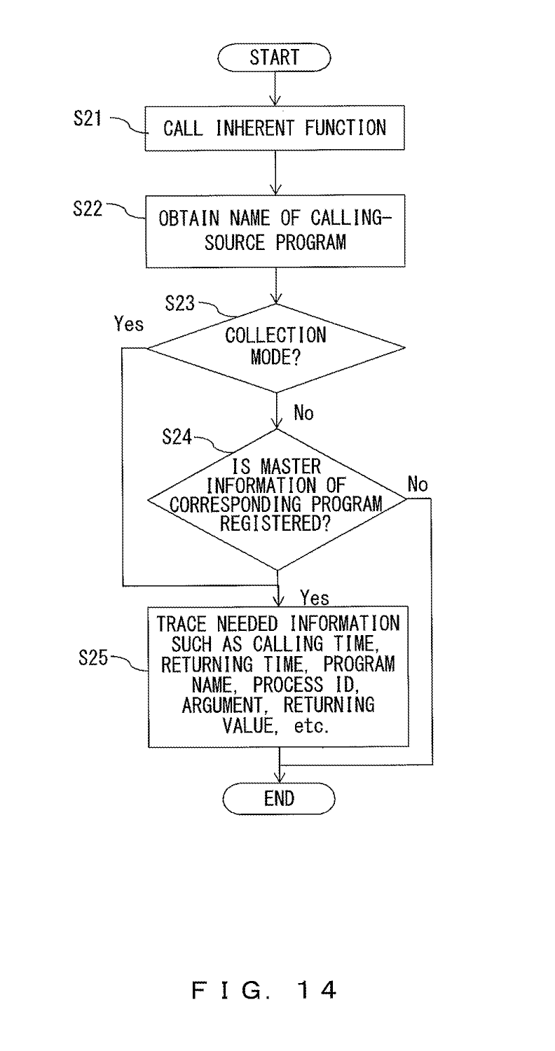

FIG. 13 illustrates a process flow of a management unit according to an example of the present embodiment. The management unit 23 sets “operation mode=1” (collection mode) in the operation mode table 35, and waits for a prescribed period of time (one week for example) (S11). Thereby, the flow illustrated in FIG. 14 is executed.

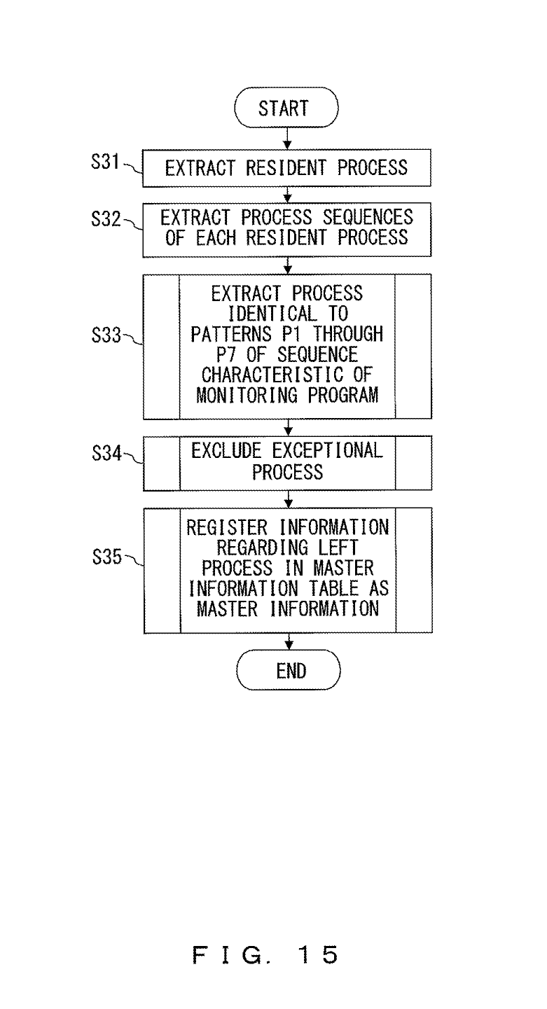

After the prescribed period of time has elapsed, the management unit 23 activates the master information registration process and waits for that process to complete (S12). Thereby, the flow illustrated in FIG. 15 is executed.

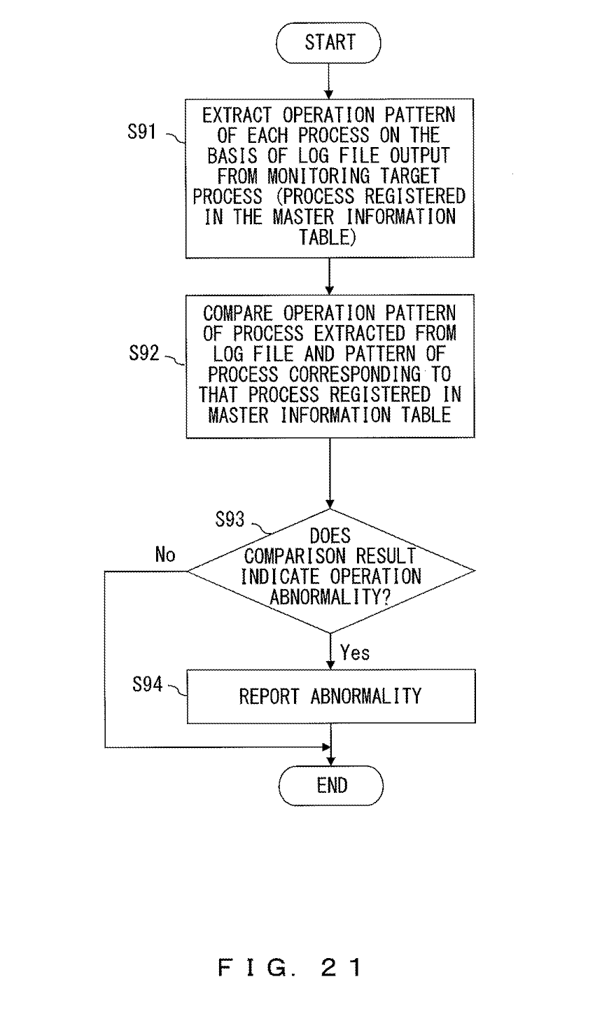

The management unit 23 sets “operation mode=2” (monitoring mode) in the operation mode table 35 and activates the monitoring process (S13). Thereby, the flow illustrated in FIG. 21 is executed.

FIG. 14 illustrates a process flow of a log output unit according to an example of the present embodiment. The library of the wrapper function is set to be used as functions used in the respective programs. The process activated by the wrapper function called from that program functions as the log output unit 42 and calls the inherent function that is wrapped (S21).

The log output unit 42 obtains the name of the calling-source program (S22). The log output unit 42 refers to the operation mode table 35 and determines the operation mode (S23). In the case of “operation mode=1” (collection mode) (Yes in S23), the log output unit 42 outputs to the log file 32 the trace information such as the calling time, the returning time, the program name, the process ID, the argument, the returning value, etc. on the basis of that process (S25) as illustrated in FIG. 7.

In the case of “operation mode=2” (monitoring mode) (“Yes” in S23), the log output unit 42 refers to the master information table 34 and determines whether or not the master information regarding the calling-source program has been registered (S24).

When the master information regarding the calling-source program has been registered (“Yes” in S24), the log output unit 42 executes the next process. Specifically, the log output unit 42 outputs to the log file the trace information such as the calling time, the returning time, the program name, the process ID, the argument, the returning value, etc. on the basis of that process (S25) as illustrated in FIG. 7.

When the master information regarding the calling-source program has not been registered (“No” in S24), the present flow is terminated.

FIG. 15 illustrates a process flow of the identifying unit according to an example of the present embodiment. The identifying unit 24 extracts a resident process on the basis of the control by the management unit (S31). In S31, the identifying unit 24 analyzes the activation time of a program (process) on the basis of the log file 32, and calculates the operation time of each program (process) from that activation time. The identifying unit 24 registers, in the operation time table 37, the operation time of each program (process) that was calculated. The identifying unit 24 determines a process that has continuously operated for a prescribed period of time or longer (one day for example) to be a resident process, and excludes other processes as non-resident processes.

Next, the identifying unit 24 extracts process sequences of each resident process from the log file 32 (S32). In S32, the identifying unit 24 extracts, from the log file 32 and in the order of time of day, functions called by a program corresponding to the resident process in S31.

Next, the identifying unit 24 extracts processes (programs) of a pattern of a process sequence identical to the master pattern information 36 from among patterns of process sequences extracted in S32 (S33). The process in S33 will be explained in detail.

Next, the identifying unit 24 excludes an exceptional process from the processes (programs) extracted in S33 (S34). The process in S34 will be explained later in detail.

Then, the identifying unit 24 registers, as master information and in the master information table 34, information regarding a process (program) that is left after S34 (S35). The process in S35 will be explained later in detail.

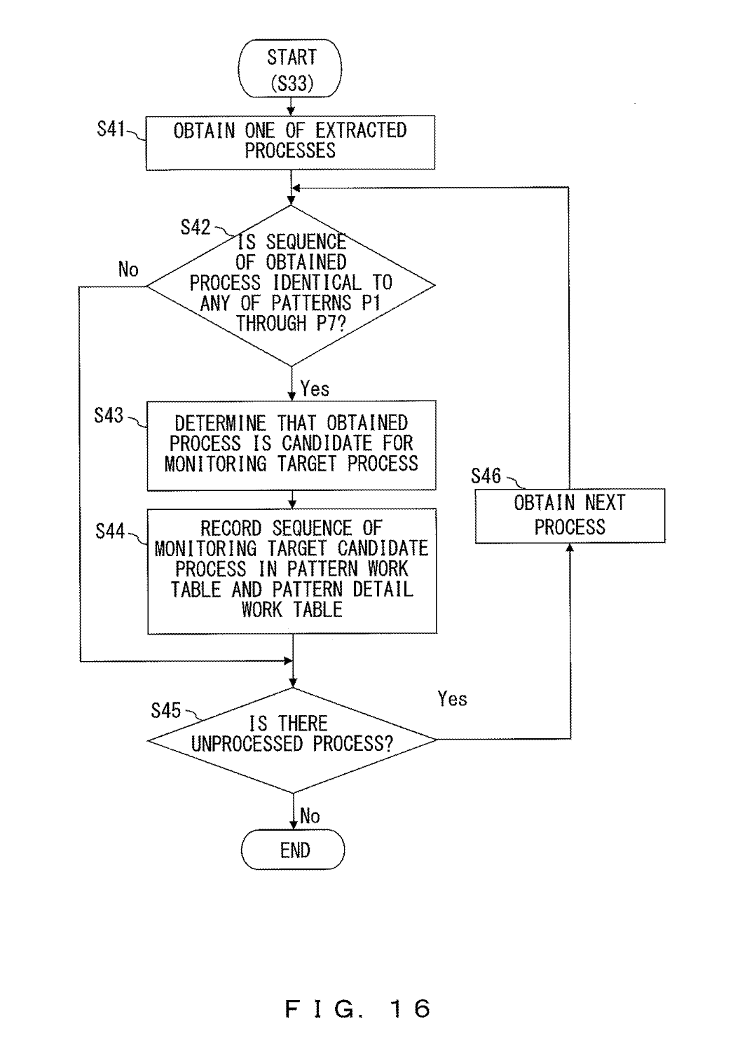

FIG. 16 illustrates the process in S33 in detail. The process in S33 is executed on all processes from which process sequences were extracted in S32.

In S32, the identifying unit 24 takes out a process sequence of one of the processes from which process sequences were extracted (S41).

The identifying unit 24 determines whether or not the taken-out process sequence of the process is identical to any of Patterns P1 through P7 that are registered in the master pattern information 36 (S42). When the taken-out process sequence of the process is not identical to any of the patterns P1 through P7 registered in the master pattern information 36 (“No” in S42), the identifying unit 24 executes the process in S45.

When the taken-out process sequence of the process is identical to any of the patterns P1 through P7 registered in the master pattern information 36 (“Yes” in S42), the identifying unit 24 determines that the taken-out process is a candidate for a monitoring target process (S43).

The identifying unit 24 registers information regarding the monitoring-target-process candidate in the pattern work table 38 and the pattern detail table 39 (S44). Specifically, the identifying unit 24 uses the log file 32 and the master pattern information 36 so as to register the entry for the monitoring-target-process candidate (items other than the interval (seconds) 38-8) in the pattern work table 38. Also, the identifying unit 24 uses the log file 32 and the master pattern information 36 so as to register the entry in the pattern detail table 39.

When there is an unprocessed process among the processes from which the process sequences were extracted in S32 (“Yes” in S45), the identifying unit 24 takes out the next process (S46) and executes S42 through S44. When the process has been completed for all the processes from which the process sequences were extracted in S32 (“No” in S45), the present flow is terminated.

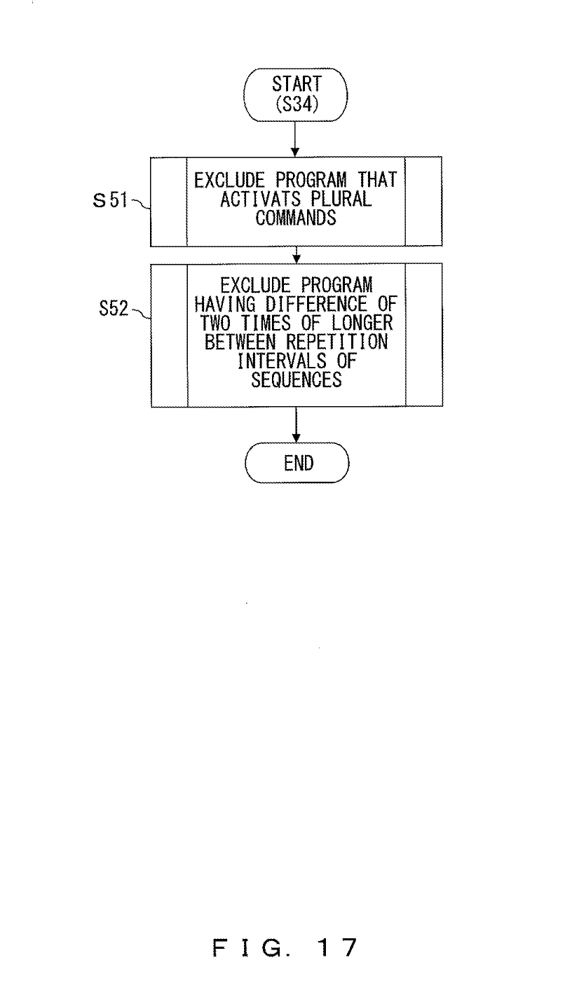

FIG. 17 illustrates the process in S34 in detail. The identifying unit 24 excludes a program that activates a plurality of commands from the monitoring-target-process candidates determined in S33 (S51).

Thereafter, the identifying unit 24 excludes, the from the monitoring-target-process candidates determined in S33, a program that has a difference of two times of longer between the repetition intervals of the process sequences (S52).

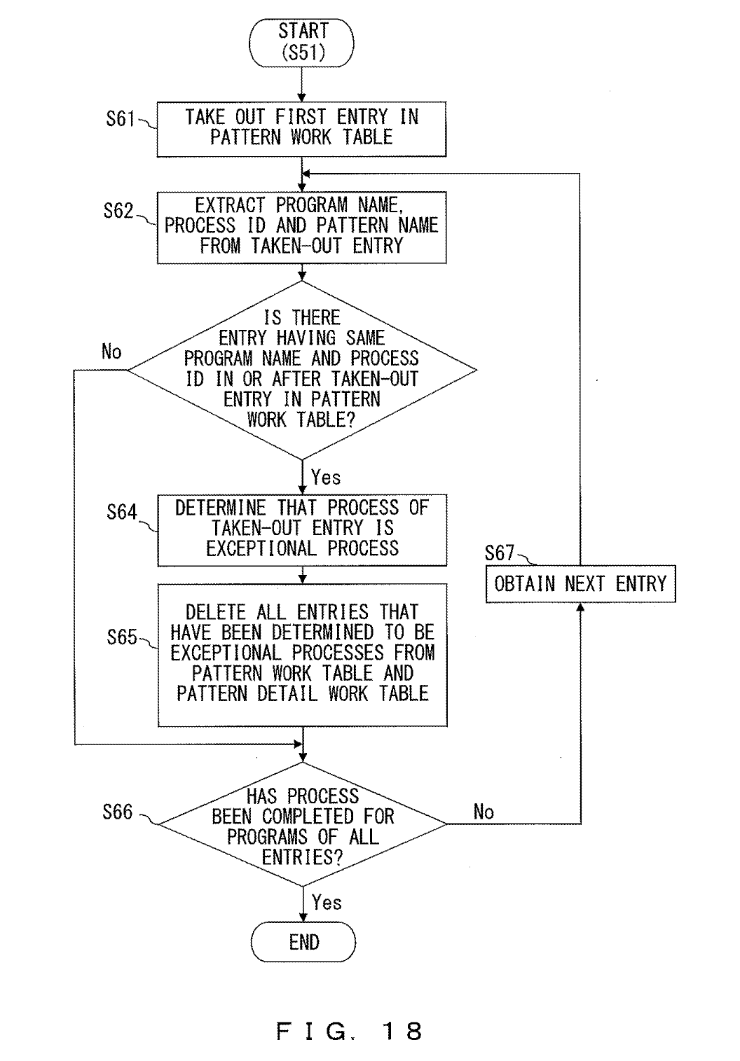

FIG. 18 illustrates the process in S51 in detail. The identifying unit 24 takes out the entry of the first program in the pattern work table 38 (S61). The identifying unit 24 extracts the program name, the process ID and the pattern name from the extracted entry (S62).

The identifying unit 24 determines whether or not there is an entry having the same program name and process ID in or after the taken-out entry in the pattern work table 38 (S63). When there is not an entry having the same program name and process ID in or after the taken-out entry in the pattern work table 38, the identifying unit 24 executes the process in S66.

When there is an entry having the same program name and process ID in or after the taken-out entry in the pattern work table 38 (“Yes” in S63), the identifying unit 24 determines that the process of that entry is an exceptional program (S64).

The identifying unit 24 deletes all entries that have been determined to be exceptional programs from the pattern work table 38 and the pattern detail work table 39 (S65).

The identifying unit 24 takes out the next entry in the pattern work table 38 (“No” in S66, S67), and executes S62 through S65. When the process has been completed for all entries that are registered in the pattern work table 38 (“Yes” in S66), the present flow is terminated.

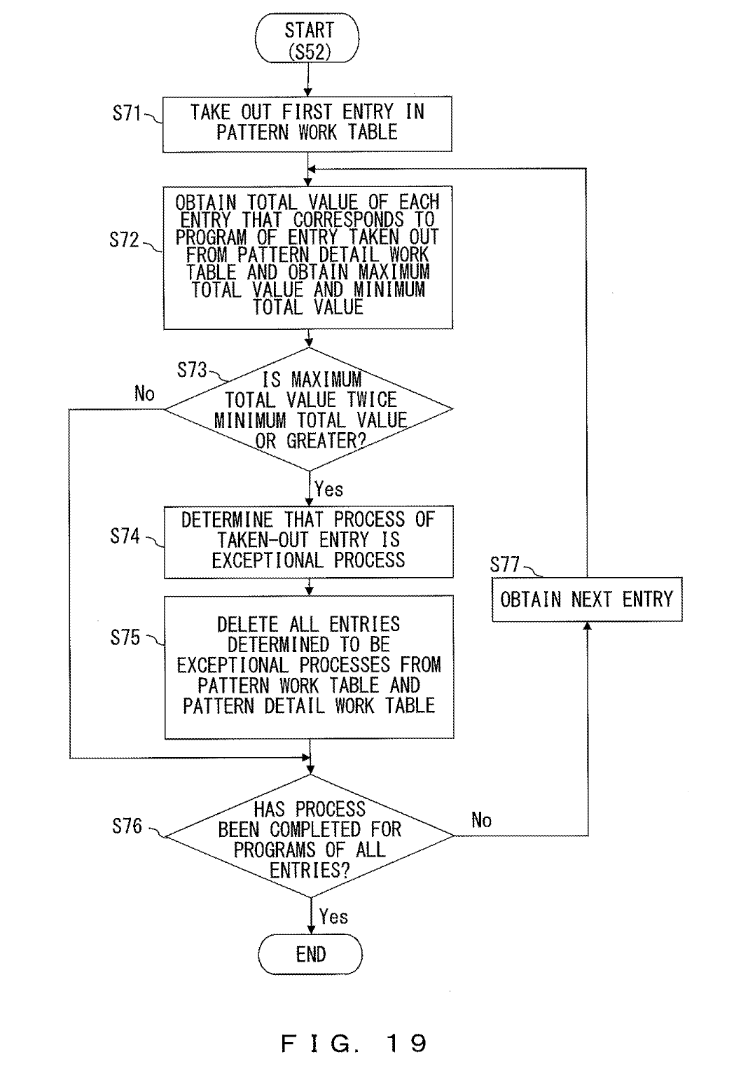

FIG. 19 illustrates the process in S52 in detail. The identifying unit 24 takes out the entry of the first program in the pattern work table 38 (S71). The identifying unit 24 obtains the total value from the “total” 39-4 of each entry that corresponds to a program of the taken-out entry. Then, the identifying unit 24 obtains the maximum total value and the minimum total value from among the obtained total values (S72).

The identifying unit 24 determines whether or not the maximum total value is twice the minimum total value or greater (S73). When the maximum total value is smaller than twice the minimum total value (“No” in S73), the identifying unit 24 executes the process in S76.

When there is a case where the maximum total value is equal to or greater than twice the minimum total value (“Yes” in S73), the identifying unit 24 determines that the process of that entry is an exceptional program (S74).

The identifying unit 24 deletes all entries that have been determined to be exceptional programs from the pattern work table 38 and the pattern detail work table 39 (S75).

The identifying unit 24 takes out the next entry in the pattern work table 38 (“No” in S76, S77) and executes S72 through S75. When the process has been completed for all the processes registered in the pattern work table 38 (“Yes” in S76), the present flow is terminated.

Although the present example determines whether or not the maximum total value is equal to or greater than n (n=2) times the minimum total value, the value of n is not limited to two, and may be a prescribed value such as for example 1.5 or other values.

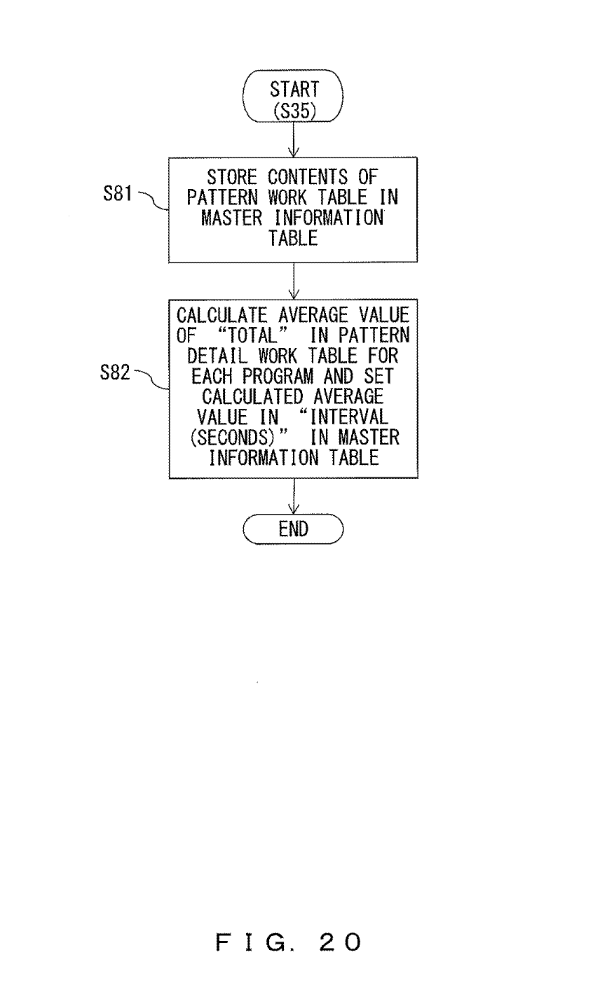

FIG. 20 illustrates the process in S35 in detail. The identifying unit 24 stores the contents of the pattern work table 38 in the master information table 34 (S81).

Then, the identifying unit 24 calculates the average value of the “total” in the pattern detail work table 39 for each program. The identifying unit 24 sets the average value of the total calculated for each program in the “argument” 34-7 in the master information table 34 (S82). Thereby, information (master information) regarding a monitoring target program (process) is registered in the master information table 34.

FIG. 21 illustrates a process flow of a monitoring unit according to an example of the present embodiment. When the monitoring mode has been set in the operation mode table 35, the log file 32 is output from a process registered in the master information table 34 as explained in FIG. 14. The monitoring unit 25 extracts an operation pattern (process sequence) of each process from the log file 32 output from a process registered in the master information table 34 (S91).

The monitoring unit 25 compares the operation pattern of the process extracted from the log file 32 and the pattern of the process corresponding to that process registered in the master information table 34 (S92).

When the result of the comparison indicates operation abnormality (“Yes” in S93), the monitoring unit 25 performs a preset operation (for example, the transmission of an e-mail that reports abnormality, the execution of a prescribed command, etc.) (S94).

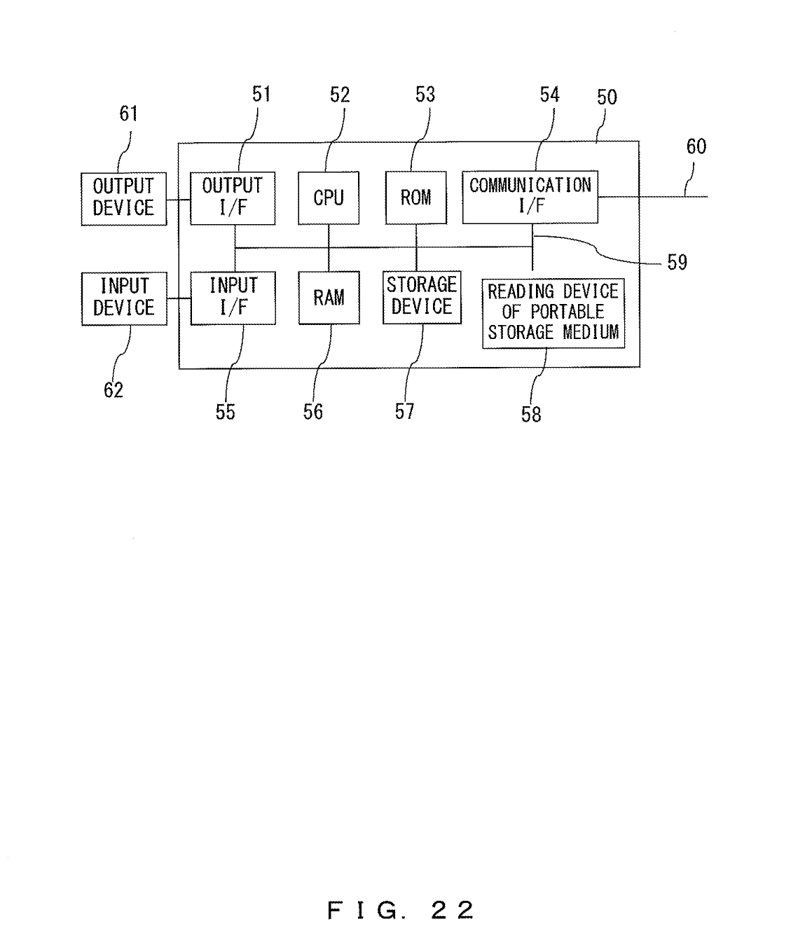

FIG. 22 illustrates an example of a configuration block diagram of a hardware environment of a computer that executes a program according to the present embodiment. A computer 50 functions as servers 11 and 21. The computer 50 includes a CPU 52, a ROM 53, a RAM 56, a communication I/F 54, a storage device 57, an output I/F 51, an input I/F 55, a reading device 58, a bus 89, an output device 61 and an input device 62.

In this example, the CPU is a central processing unit. The ROM is a read only memory. The RAM is a random access memory. The I/F is an interface. To a bus 59, the CPU 52, the ROM 53, the RAM 56, the communication I/F 54, the storage device 57, the output I/F 51, the input I/F 55 and the reading device 58 are connected. The reading device 58 is a device that reads information from a portable recording medium. The output device 61 is connected to the output I/F 51. The input device 62 is connected to the input I/F 55.

It is possible to use various types of recording devices such as a hard disk, a flash memory, a magnetic disk, etc. as the storage device 57. In the storage device 57 or the ROM 53, a program that makes the CPU 52 function as the management units 13 and 23, the collection unit 14, the log output unit 42, the identifying units 15 and 24 and the monitoring units 16 and 25 are stored. In the storage device 57 or the ROM 53, the log file 32, the management DB 33, the operation mode table 37, the pattern work table 38 and pattern detail work table 39 are stored. In the RAM 56, the information is stored temporarily.

The CPU 52 reads a program according to the present embodiment, and executes that program.

A program that realizes the processes explained in the above embodiment may be stored in for example the storage device 57 by a program provider side via a communication network 60 and the communication I/F 54. Also, a program that realizes the processes explained in the above embodiment may be stored in a commercially available portable storage medium. In such a case, the portable storage medium may be set in the reading device 58 so that the program is read and executed by the CPU 52. As a portable storage medium, various types of storage media such as a CD-ROM, a flexible disk, an optical disk, a magneto-optical disk, an IC card, a USB memory device, etc. may be used. A program stored in such a storage medium is read by the reading device 58.

Also, as the input device 62, a keyboard, a mouse, an electronic camera, a web camera, a microphone, a scanner, a sensor, a tablet, etc. can be used. Also, a display device, a printer, a speaker, etc. can be used as the output device 61. Also, the network 60 may be the Internet, a LAN, a WAN, a wired or wireless communication network, a communication network of a dedicated line, etc.

According to an aspect of the present invention, it is possible to select a program that is to be a monitoring target in a monitoring target system.

The present invention is not limited to the embodiment described above, and various configurations or embodiments can be employed without departing from the spirit of the present invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A selection method for selecting a monitoring target program, the selection method comprising:
identifying, by using a computer, a program in which a command history issued to an operating system meets a specific pattern from among a plurality of programs run in a monitoring target system; and
selecting, by using the computer, one or more residual programs as a monitoring target, the one or more residual programs being obtained by excluding the identified program from the plurality of programs.

2. The selection method according to claim 1, wherein
the identifying includes
extracting, from the command history, a program that is run continuously for a specific period of time and that executes sequential-continuous processes identical to pattern information obtained from a storage unit, the pattern information including a pattern of sequential-continuous processes that are executed sequentially and continuously in the program,
measuring each execution time of the sequential-continuous processes that are executed for a plurality of times in a same program among the extracted programs, and
identifying a program that meets a specific pattern in accordance with a ratio between a maximum execution time and a minimum execution time that were measured.

3. The selection method according to claim 2, wherein
the identifying further includes identifying a program that meets a specific pattern on the basis of whether or not a same program has been executed for a plurality of times from among the extracted programs.

4. A non-transitory computer-readable recording medium having stored therein a program for causing a computer to execute a process for selecting a monitoring target, the process comprising:
identifying a program in which a command history issued to an operating system meets a specific pattern from among a plurality of programs run in a monitoring target system; and
selecting one or more residual programs as a monitoring target, the one or more residual programs being obtained by excluding the identified program from the plurality of programs.

5. The non-transitory computer-readable recording medium according to claim 4, wherein
the identifying includes:
extracting, from the command history, a program that is run continuously for a specific period of time and that executes sequential-continuous processes identical to pattern information obtained from a storage unit, the pattern information including a pattern of sequential-continuous processes that are executed sequentially and continuously in the program;
measuring each execution time of the sequential-continuous processes that are executed for a plurality of times in a same program among the extracted programs; and
identifying a program that meets a specific pattern in accordance with a ratio between a maximum execution time and a minimum execution time that were measured.

6. The non-transitory computer-readable recording medium according to claim 5, wherein
the identifying further includes identifying a program that meets a specific pattern on the basis of whether or not a same program has been executed for a plurality of times from among the extracted programs.

7. A monitoring target selection apparatus comprising
a processor that executes a process including:
identifying a program in which a command history issued to an operating system meets a specific pattern from among a plurality of programs run in a monitoring target system; and
selecting one or more residual programs as a monitoring target, the one or more residual programs being obtained by excluding the identified program from the plurality of programs.

8. The monitoring target selection apparatus according to claim 7, wherein
the identifying includes:
extracting, from the command history, a program that is run continuously for a specific period of time and that executes sequential-continuous processes identical to pattern information obtained from a storage unit, the pattern information including a pattern of sequential-continuous processes that are executed sequentially and continuously in the program,
measuring each execution time of the sequential-continuous processes that are executed for a plurality of times in a same program among the extracted programs, and
identifying a program that meets a specific pattern in accordance with a ratio between a maximum execution time and a minimum execution time that were measured.

9. The monitoring target selection apparatus according to claim 8, wherein
the identifying further includes identifying a program that meets a specific pattern on the basis of whether or not a same program has been executed for a plurality of times from among the extracted programs.
